(19) United States
(12) Patent Application Publication
(10) Pub. No.: US 2006/0024147 A1
(43) Pub. Date: Feb. 2, 2006

(54) Screw for hard materials

(76) Inventor: Andreas Wunderlich, Kupferzell (DE)

Correspondence Address: QUARLES & BRADY LLP, 411 E. WISCONSIN AVENUE, SUITE 2040, MILWAUKEE, WI, 53202-4497, US

(21) Appl. No.: 10/533,990

(22) PCT Filed: Oct. 9, 2003
(86) PCT No.: PCT/EP03/11157

§ 371 Date: May 4, 2005

(30) Foreign Application Priority Data
Nov. 7, 2002 (DE) 102 52 774.1

(51) Int. Cl. F16B 39/30

(52) U.S. Cl. 411/308; 411/411

(57) ABSTRACT

A screw intended for use on hard masonry or concrete has a thread that constitutes a row of teeth bordering on one another that are offset laterally with respect to the thread's longitudinal axis. The thread has a sawtooth contour.

The invention is based on a screw for use on hard materials, in particular, masonry and concrete. Such screws are also termed “concrete screws,” and are screwed into predrilled holes in masonry, where their thread then cuts a mating thread in the walls of the drilled holes. Employing concrete screws has the advantages that, with the exception of drilling the holes, no further measures are necessary, and that they may be subjected to loads as soon as they have been screwed in place.

A known concrete screw of that type (cf. European Patent EP 433484 B) has a thread whose sides make an acute included angle with one another. The crest of its thread has notches, each of which has a cutting edge that is flush with the crest of its thread.

In the case of another concrete screw of that type (cf. German Patent DE 197 35 280), the sides of its thread are parallel to one another and orthogonal to the longitudinal axis of the screw's shaft.

A similar concrete screw is known from European Patent EP 916030. That screw also has roughly V-shaped notches, where the leading and trailing edges of the notches are symmetrically disposed with respect to a radial line passing through the screw's longitudinal axis. Giving the teeth a set is known from German Patent DE 197 24 052. However, that has the disadvantage that such sets cannot be economically manufactured in the case of screws. The thread may be broadened over that portion thereof immediately adjoining the shaft, i.e., that portion of the thread that does not penetrate the walls of drilled holes. An annular gap between the outer surface of the shaft and the walls of drilled holes must be left vacant.

The problem addressed by the invention is creating a simply manufactured screw having a good grip that may be readily screwed in place.

In order to solve that problem, the invention proposes a screw having those features stated under claim 1. Elaborations on the invention are covered by subclaims.

Giving teeth a set is a measure commonly employed in the case of saw blades, and involves alternately bending the teeth of a saw blade to the right and left of a centerline. Such measures are presently unknown in the case of a thread. Although saws are primarily employed for generating a cut, which should be broader than the remainder of the saw's blade, in the case of concrete screws, the objective is giving them a better grip. Surprisingly, that may also be achieved using a thread having a set, since the thread, or its crests, progressively scrape off material, that is, scrape off material as the depth to which screws have been screwed in increases.

Under an elaboration on the invention, it may be provided that the thread has a sawtooth profile. Although giving its teeth a set is a measure that will become apparent when screws are viewed from the side, the sawtooth profile is a profiling of their thread that will become apparent when screws are viewed along their longitudinal axis. The notches that remain between the teeth of the sawtooth profile are asymmetric notches, for which the leading edges of the sawteeth, i.e., the trailing surfaces of the notches, are roughly radially disposed with respect to screws' longitudinal axis.

Under a further elaboration on the invention, it may be provided that the crest of the thread is flattened, forming a narrow crest, i.e., that a surface bounded by edges, rather than a sharp crest, is formed, which will enlarge the thread's cross-sectional area in order that the forces that need to be exerted in order to withdraw the screw will be increased.

Under an elaboration on the invention, it may be provided that the crest of the thread has edges running across it, regardless of whether it is flattened. Those edges will then be parallel to screw's longitudinal axis.

Under a further elaboration on the invention, it may be provided that at least one side of the thread, preferably both sides of the thread, have alternating protrusions and notches. Although a side of a thread normally follows a spiral path, i.e., has a smooth surface, in this case, its surface contains notches whose bases are parallel to the remaining portions of that side of the thread, but offset with respect thereto.

That approach will allow achieving what is proposed under an elaboration on the invention, namely, that the at least one side of the thread also forms edges that are roughly radially disposed. Under an elaboration thereon, those radially disposed edges may be extensions of the leading edges of the sawteeth.

According to the invention, it may be provided that the thread has a row of laterally offset teeth bordering on one another, where it may be provided that the radial edges of the sides of the thread extend all the way down to the screw's shaft, while the notches between the teeth preferably do not extend all the way down to the screw's shaft.

The included angle between the outer sections of the sides of the thread, i.e., those sections thereof adjoining the crest of the thread falls within the range extending from around 200 to around 300. Involved here is that portion of the thread that is supposed to penetrate the walls of drilled holes. An annular gap is left between the surface of the shaft and the walls of drilled holes. In the vicinity of that gap, the included angle between the sides of the thread may be larger in order to give the screw a better grip.

When giving the edges of the crest of the thread a set, according to the invention, it may be provided that the teeth are offset with respect to one another by the width of their face. When unwound and flattened out, the thread will thus appear to be a row of laterally offset rectangles whose right-hand edge is aligned on the left-hand edge of the next rectangle.

According to the invention, it may be provided that the number of teeth per unit length of thread, in other words, the dimensions of the teeth, as measured along the path followed by the thread, and/or the set of the teeth, and/or the depth of the notches between the teeth vary/varies over the length of the screw's shaft. A more prominent set may be required, or sensible, at those locations where most of the work needed for cuffing threads in masonry is performed, while a less prominent set, or fewer teeth per unit length of thread, may be sensible over the remainder of the thread extending from those locations up to the screw's head, where those threads have already been cut.

Other features, details, and benefits of the invention will be evident from the claims and the abstract, whose wordings are herewith made an integral part of this description by way of reference thereto, the following description of a preferred embodiment of the invention, and the figures, which depict:

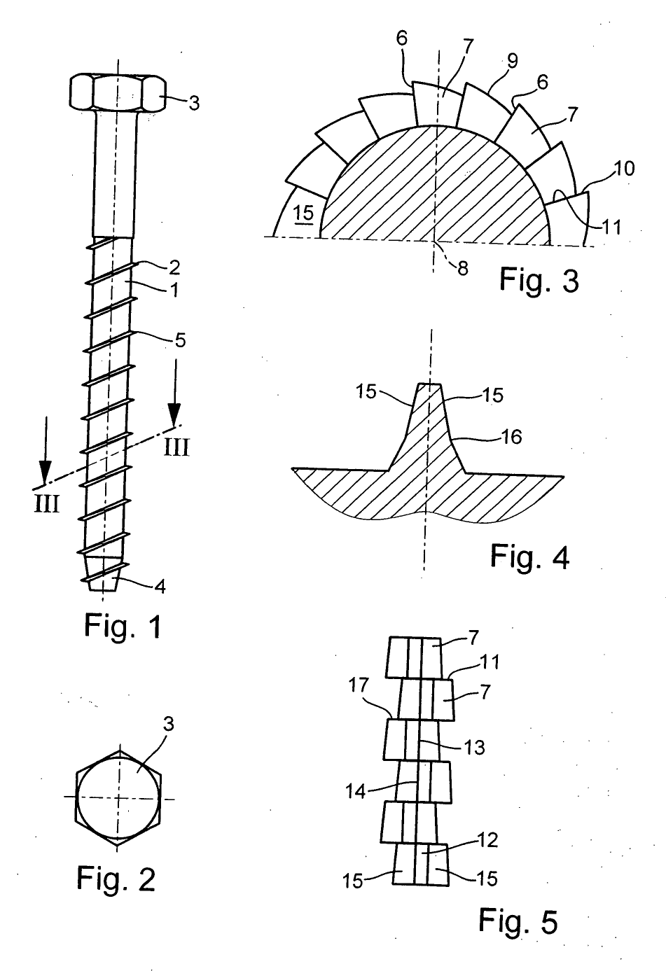

FIG. 1 a side view of a concrete screw proposed by the invention;

FIG. 2 a top view of the screw shown in FIG. 1;

FIG. 3 a view of the screw's shaft, diagonally sectioned and drawn on an enlarged scale;

FIG. 4 a broken-out view of the screw's shaft, longitudinally sectioned in the vicinity of one of its threads and drawn on an enlarged scale;

FIG. 5 a top view of a single circuit of its thread, shown here unwound and flattened out.

FIG. 1 depicts a side view of a screw of the general type proposed by the invention.

The screw contains a shaft 1 that is provided with a thread 2 extending over most of its length. A head 3 that, in this particular case, is a hexagonal head, is arranged on one end of its shaft 1. However, the shape and dimensions of its head are nonessential to the invention, since the screw may also be set in rotation by means of any other sort of head.

The diameter of the screw's shaft decreases at that end thereof opposite its head 3, forming a truncated cone.

The thread 2 has a constant pitch, a constant major diameter, and follows a spiral path, where it may be seen from FIG. 1 that its crest 5 is flattened.

FIG. 2 depicts a top view of the screw's head 3, which, as has been stated above, is a hexagonal head. However, a head having a transverse slot for accepting the blade of a typical screwdriver would also be feasible.

FIG. 3 depicts a partial view of the screw, diagonally sectioned along, for example, the line III-III in FIG. 1, and drawn on an enlarged scale. The crest of its thread has a sawtooth profile. The leading edge 6 of every tooth 7 lies on a line passing through the centerline of the sectioned partial view, i.e., through the screw's longitudinal axis 8. The outer edge 9 of every tooth thus follows a broad arc extending from the leading edge 6 of that tooth to the leading edge 6 of the next tooth 7. Notches 10, whose depth is around one-fourth the radial extension of the teeth 7, are formed between the teeth.

The leading edges 6 of the teeth, which are actually surfaces, blend into radial edges 11 on the teeth 7, where those edges 11 are configured in the form of either the leading edge of a tooth or the trailing edge of a tooth.

The arrangement of the teeth may best be seen in FIG. 5, which depicts a single circuit of the thread, unwound along, for example, the direction indicated by the arrow V shown in FIG. 3, and flattened out. In this top view thereof, the flattened crest of the thread forms a rectangular face 12 whose lateral edges follow the same spiral path followed by the thread 2. The individual teeth 7 are spaced such that the right-hand edge 13 of their face 12 is aligned on the left-hand edge 14 of the face 12 of a neighboring tooth. The sides 15 of the thread may be seen on either side of their faces 12. The sides 15 of the thread diverge from the flattened crest formed by their faces 12, where the included angle between its sides in that vicinity is around 20° to 30° (cf. FIG. 4). The straight slope of the sides 15 of the thread, which is depicted in a broken-out sectioned view in FIG. 4, extends down to a location 16 where the included angle between the sides 15 of the thread increases. The wall of a drilled hole will be arranged at that location 16 when the screw is screwed into it. The included angle between the sides of its thread will thus fall within the range extending from around 20° to around 30° over that portion of its thread that penetrates the wall of the drilled hole. The included angle between the sides 15 of its thread is larger than that only over that portion thereof that remains outside the wall of the drilled hole.

As may also be seen from FIG. 5, the leading edges 11 of the teeth 7 form cutting edges that scrape material off masonry or concrete. From FIG. 5, it may also be seen that the sides of the thread alternately protrude and are recessed, where the surfaces of the respective segments thereof involved will be parallel to one another when the thread is unwound and flattened out.

1. A screw for use on hard materials, such as concrete or masonry, having
a shaft (1),
a head (3) in the vicinity of one end of the shaft (1),
a tip (4), and
a thread (2), wherein cutting teeth that are formed on a side of the thread that faces away from the head are alternately inclined to the left and right of a centerline over their full lengths.

2. A screw according to claim 1, wherein the thread (2) has a sawtooth profile.

3. A screw according to claim 2, wherein the leading edges (6) of the sawteeth (7) are roughly radially disposed with respect to the screw's longitudinal axis (8).

4. A screw according to claim 1, wherein the crest of its thread is flattened, forming a narrow face (12).

5. A screw according to claim 1, wherein the crest of the thread has edges extending across it.

6. A screw according to claim 1, wherein at least one side of its thread has alternating protrusions and notches.

7. A screw according to claim 1, wherein at least one side of the thread has roughly radially disposed edges (11, 17).

8. A screw according to claim 1, wherein the thread (2) has a row of laterally offset teeth (7) bordering on one another.

9. A screw according to claim 7, wherein the radially disposed edges (11, 17) of the sides (15) of the thread extend all the way down to the screw's shaft (1).

10. A screw according to claim 2, wherein the notches (10) between the teeth (7) do not extend all the way down to the screw's shaft (1).

11. A screw according to claim 1, wherein the included angle between the sides (15) of the thread falls within the range extending from around 20 degrees to 30 degrees over that portion thereof that is supposed to penetrate the wall of a drilled hole.

12. A screw according to claim 1, wherein the included angle between the sides (15) of the thread falls within the range extending from around 40 degrees to around 60 degrees over the transition zone immediately adjoining its shaft (1).

13. A screw according to claim 2, wherein the teeth (7) are offset from one another by the width of their face (12).

14. A screw according to claim 1, wherein the number of teeth (7) per unit length of thread, and/or the set of the teeth (7), and/or the depths of the notches (10) between the teeth (7) vary/varies over the length of the screw's shaft (1).
